(19) United States
(12) Patent Application Publication
(10) Pub. No.: US 2003/0213392 A1
(43) Pub. Date: Nov. 20, 2003

(54) Method for improving printing press hygiene

(75) Inventors: Nicholas James Nissing, Cincinnati, OH (US); Amanda K. Jones, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/151,611

(22) Filed: May 20, 2002

(51) Int. Cl. B41F 5/00

(52) U.S. Cl. 101/483; 101/216; 101/395; 101/425

(57) ABSTRACT

The present invention relates to a print element design which can be used to print an image on a substrate such as an absorbent disposable paper product. This invention also relates to a print plate which incorporates this print element design. The invention further relates to an absorbent disposable paper product which incorporates this element design. The print element design of the present invention reduces ink and fiber adherence to the printing plates thus resulting in improved printing press hygiene.

### FIELD OF THE INVENTION

This invention relates to the manufacture of printed paper products and methods for improving printing press hygiene.

### BACKGROUND OF THE INVENTION

Applying images to paper products by utilizing pigment or dye based ink compositions is well known in the art. One of the difficulties historically experienced with absorbent disposable paper products (including facial tissue, bath tissue, table napkins, wipes, cotton pads, and the like) printed with pigment based ink compositions is the tendency for the ink to rub-off of the surface of the paper upon exposure of the paper to liquids. The problem is even more pronounced for those absorbent disposable paper products printed with inks exhibiting relatively high color densities.

The tendency for the ink to rub-off increases as the printed absorbent disposable paper product is exposed to liquids such as tap water. Furthermore, exposing the absorbent disposable paper product printed with ink to common household cleaning products containing solventized alkaline liquids, or acid-containing cleaning liquids tends to increase ink rub-off as compared to exposure of the paper to tap water alone.

Commonly assigned U.S. Pat. No. 6,096,412 issued to McFarland et al. on Aug. 1, 2000, teaches an absorbent disposable paper product having inks with improved rub-off resistance (i.e.; inks which exhibit improved adherence to the paper).

Inks which exhibit strong adherence to a substrate often exhibit similar adherence properties to the plates on a printing press. This is evident whether the printing plates are segmented plates, mounted on sleeves, or attached in another manner to the print cylinder of the printing press. This is particularly evident when utilizing the flexographic printing processes. In particular, flexographic printing plates tend to accumulate ink deposits which can eventually lead to print defects in the printed paper product. The flexographic printing process is the method by which disposable paper products have traditionally been printed.

The flexographic printing process has typically utilized halftone printing to convey an image from the printing plate to a substrate. As used herein, “halftone printing” refers to a method of printing which utilizes a plurality of dots to form the print image. Flexographic print plates commonly incorporate print elements which are comprised of dots. The dots, which are raised from the surface of the plate, transfer ink from a source to the paper in a predetermined pattern. As used herein, “print element” refers to the individual indicium which form the print image. Dots have traditionally been preferred as they are symmetric along any axis and are most likely to avoid moiré interaction. Furthermore, because of their radial symmetry and small surface area, dots would be expected to accumulate less ink, fiber, and other contaminants in comparison to other print element shapes.

With regard to the flexographic printing process, it has been found that printing plates comprised of dots tend to hold up particularly well to the printing plate-making process. However, it has been found that a plurality of these dots create recessed valleys in the printing plate which easily accumulate contaminants such as excess ink and fiber. As ink and fiber accumulate on the printing plate, the printing press must be frequently stopped in order to clean the plates. The recessed areas of the plate are difficult to clean using traditional mechanical printing plate cleaning devices such as rotary brushes.

Hence, it would be desirable to utilize a printing plate print element design which reduces the degree to which contaminants accumulate on the printing plate. It would also be desirable to utilize a printing plate print element design which is compatible and may be used in combination with traditional printing plate cleaning devices in order to significantly reduce printing press downtime due to plate cleaning.

In light of the prior art it is unexpected to find that substrates including but not limited to absorbent disposable paper products can be effectively printed with linear print elements without adversely impacting the appearance of the print. This is surprising in that one would expect linear print elements to significantly alter the appearance of the printed product. Unlike dots, linear print elements are not radially symmetrical. Hence, one would expect a linear print element to have a non-uniform appearance. In addition, one would expect the use of linear print elements to interfere with color overlays in a manner similar to moiré interactions.

Furthermore, with respect to printing press hygiene, it is surprising to find that printing plates comprised of linear print elements are more effectively cleaned by typical printing press mechanical cleaning systems than are print elements comprised of dots. The benefit of this invention is the ability to improve printing press hygiene and efficiency while maintaining the appearance, performance, and quality of the printed paper.

### SUMMARY OF THE INVENTION

The present invention relates to a linear print element. The linear print element has an aspect ratio of at least about 2, preferably at least about 3, and more preferably at back least about 5.

In another aspect the present invention relates to a printing plate for a printing press wherein the printing plate comprises at least one linear print element. The linear print element, which has one dimension that is oriented substantially parallel to the machine direction of the printing press, has an aspect ratio of at least about 2.

In yet another aspect, the present invention relates to a printed paper product wherein the paper product includes an image comprised of one or more linear print elements having an aspect ratio of at least about 2 and preferably a plurality of linear print elements. The printed paper product may be flexographically printed. The image may be a process print. The paper product may be an absorbent disposable paper product.

In a further aspect, the present invention relates to a system for improving printing press hygiene. The system includes providing a flexographic printing press having at least one flexographic print plate and providing a print plate cleaning device. The flexographic print plate is comprised of linear print elements. The cleaning device may contact the print plate on an intermittent basis. The print plate cleaning device may be comprised of a rotary brush cleaning system. The linear print elements may be aligned substantially parallel to the machine direction of the flexographic printing press. The linear print elements may be aligned substantially parallel with the motion of the brushes of the rotary brush cleaning system.

In yet a further aspect, the present invention relates to a method for printing on absorbent disposable paper. The method comprises the steps of:

(a) providing an absorbent disposable paper;

(b) providing a flexographic printing plate wherein the plate is comprised of a plurality of linear print elements which forms an image whereby each individual linear print element has an aspect ratio of at least about 2;

(c) applying ink to the linear print elements; and

(d) contacting the linear print elements to the absorbent disposable paper so as to transfer the image from the linear print elements to the absorbent disposable paper.

The flexographic printing plate may be segmented or mounted on a sleeve.

All documents cited herein are hereby incorporated by reference.

### BRIEF DESCRIPTION OF THE DRAWINGS

FIG. 1 is a flexographic print plate made according to the present invention.

FIG. 2 is a flexographic print plate made according to the prior art.

FIG. 3A is a print image made according to the prior art.

FIG. 3B is a print image made according to the present invention.

FIG. 4A is a print image made according to the prior art.

FIG. 4B is a print image made according to the present invention.

FIG. 5 illustrates a system according to the present invention for improving printing press hygiene.

### DETAILED DESCRIPTION OF THE INVENTION

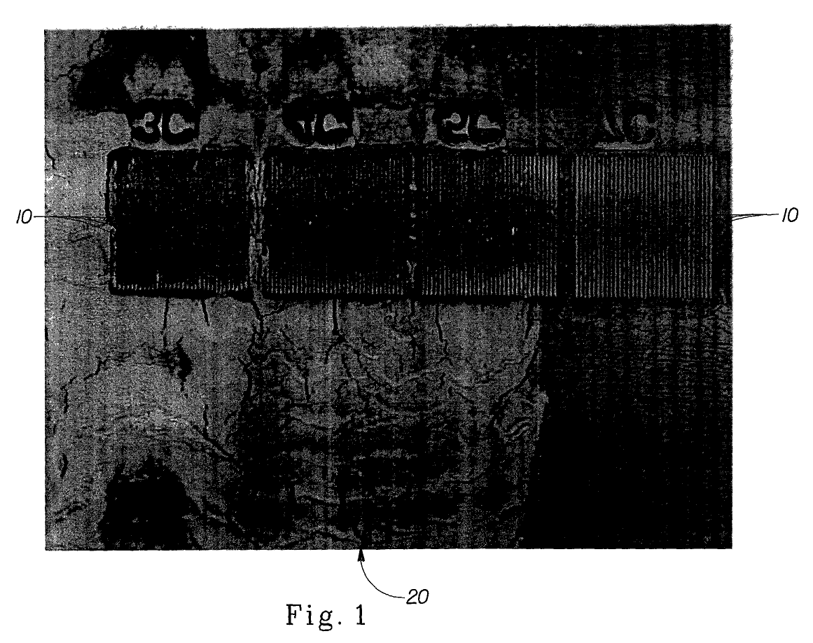

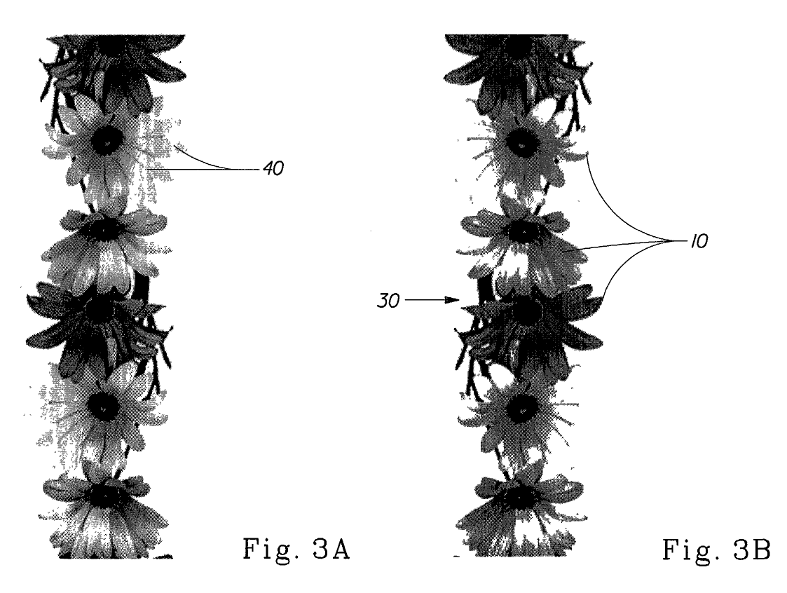

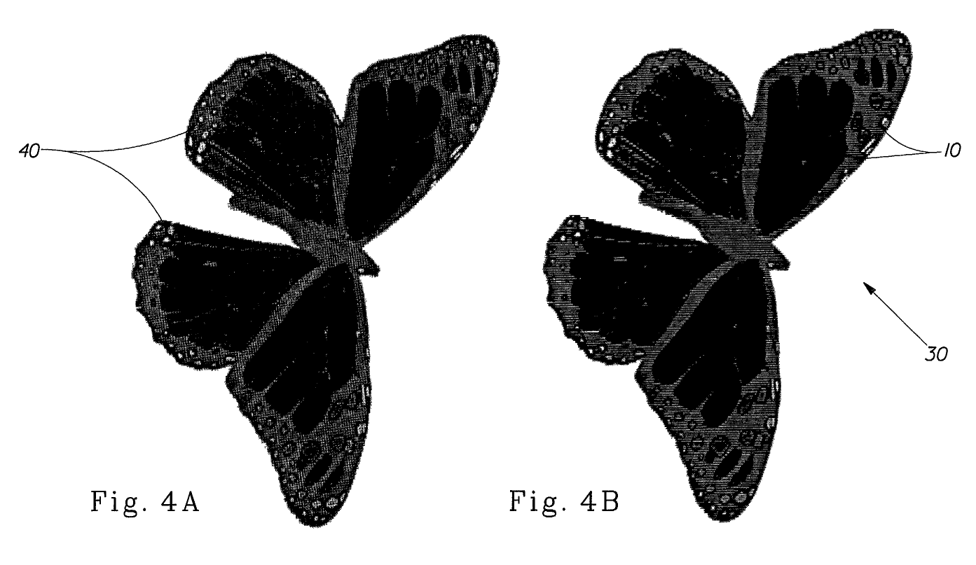

Referring to FIG. 1, the present invention relates to a linear print element 10 which can be used to print an image on a substrate. Referring to FIGS. 3B and 4B, the present invention also relates to a print image 30 comprised of linear print elements 10. Referring to FIG. 1, the present invention further relates to a print plate 20 comprised of linear print elements 10 used to produce the print image 30 of FIGS. 3B and 4B. Yet further, the present invention relates to a system for improving printing press hygiene.

Print Element:

The linear print element 10 of this invention is comprised of one dimension which is oriented substantially parallel to the direction of movement of the printing press (i.e.; the machine direction of the printing press) and a second dimension which is oriented substantially perpendicular to the direction of movement of the printing press (i.e.; the cross direction of the printing press). With regard to a substrate, the machine direction of the substrate typically has a higher degree of stretch than the cross direction. For creped tissue products, this direction is generally perpendicular to the orientation of the crepe ridges.

The linear print element 10 may be of any shape so long as the aspect ratio between the machine direction dimension and the cross direction dimension is at least about 2. Preferably the aspect ratio is at least about about 3, and even more preferably at least about 5.

A macroscopic print image 30 may be comprised in part or entirely of linear print elements 10. As used herein, “macroscopic” refers to any region which can be resolved by the naked human eye at a distance of about 0.8 meters or greater. As used herein, “solid print” refers to a printed area without discernable print elements. For example in the case of a flexographically printed substrate, a solid print is the printed area of the substrate that corresponds to the 100% raised (i.e.; solid) surface on a flexographic printing plate. In the case of line printing, all of the printed regions are solids.

The linear print elements 10 of the present invention are distinct from line printing in that the print image 30 comprised of linear print elements 10 is a halftone image which may comprise color density gradations. As used herein, “halftone image”, refers to print images 30 comprised of discrete print elements.

As used herein “color density” is defined by the following equation:

D=log ₁₀I/R

wherein I, refers to the intensity of incident light, and R, refers to the intensity of reflected light.

While there are many different ways to print onto a substrate using one color or multiple colors of ink, the present invention may be particularly applicable when printing on substrates that utilize inks which have low color contrast to the background color of the substrate (for example when printing yellow ink onto a white, off-white, or yellow substrate). Therefore, the linear print elements 10 of the present invention may be used in conjunction with one color ink of a multi-color print if desired.

As used herein, “image area”, “print region”, or “print area” are interchangeable terms that refer to the macroscopic region or area of the substrate which exhibits the print image 30.

As used herein, “% print element coverage” refers to the amount of a specified print area covered by print elements in relation to the total specified print area.

Substrate:

Though the present invention is applicable to any type of substrate, preferably the substrate of the present invention is an absorbent disposable paper product. Non-limiting examples of absorbent disposable paper products include but are not limited to bath tissue, facial tissue, table napkins, towelling, wipes, cotton pads, absorbent disposable garments and articles, and the like. The substrate of the present invention typically has a basis weight of between about 10 g/m² and 130 g/m², preferably between about 20 g/m² and 80 g/m², and most preferably between about 25 g/m² and 60 g/m². The substrate may be composed of materials that are cellulosic, non-cellulosic, or a combination thereof.

The substrate of this invention has a first outer surface and a second outer surface wherein the second outer surface is oppositely disposed to the first outer surface. Indicium is applied to at least one of the first or second outer surfaces. The indicium may be applied with ink.

The substrate of this invention may be made according to commonly assigned U.S. Pat. No.: 4,191,609 issued Mar. 4, 1980 to Trokhan; U.S. Pat. No. 4,300,981 issued to Carstens on Nov. 17, 1981; U.S. Pat. No. 4,514,345 issued to Johnson et al. on Apr. 30, 1985; U.S. Pat. No. 4,528,239 issued to Trokhan on Jul. 9, 1985; U.S. Pat. No. 4,529,480 issued to Trokhan on Jul. 16, 1985; U.S. Pat. No. 4,637,859 issued to Trokhan on Jan. 20, 1987; U.S. Pat. No. 5,245,025 issued to Trokhan et al. on Sep. 14, 1993; U.S. Pat. No. 5,275,700 issued to Trokhan on Jan. 4, 1994; U.S. Pat. No. 5,328,565 issued to Rasch et al. on Jul. 12, 1994; U.S. Pat. No. 5,334,289 issued to Trokhan et al. on Aug. 2, 1994; U.S. Pat. No. 5,364,504 issued to Smurkowski et al. on Nov. 15, 1995; U.S. Pat. No. 5,366,785 issued to Sawdai on Nov. 2, 1994; U.S. Pat. No. 5,527,428 issued to Trokhan et al. on Jun. 18, 1996; U.S. Pat. No. 5,529,664 issued to Trokhan et al., on Jun. 25, 1996; U.S. Pat. No. 5,556,509 issued to Trokhan et al. on Sep. 17, 1996; U.S. Pat. No. 5,628,876 issued to Ayers et al. on May 13, 1997; U.S. Pat. No. 5,629,052 issued to Trokhan et al. on May 13, 1997; U.S. Pat. No. 5,637,194 issued to Ampulski et al. on Jun. 10, 1997; and U.S. Pat. No. 5,679,222 issued to Rasch et al., on Oct. 21, 1997, the disclosures of which are incorporated herein by reference for the purpose of showing how to make a substrate suitable for use with the present invention.

The substrate may also be made according to U.S. Pat. No. 5,411,636 issued to Hermans et al. on May 2, 1995 and EP 677612 published in the name of Wendt et al. on Oct. 18, 1995.

The substrate of the present invention may be through air dried or conventionally dried. Optionally, it may be foreshortened by creping or by wet microcontraction. Creping and wet microcontraction are disclosed in commonly assigned U.S. Pat. No.: 4,440,597 issued to Wells et al. on Apr. 3, 1984 and U.S. Pat. No. 4,191,756 issued to Sawdai on May 4, 1980, the disclosures of which are incorporated herein by reference.

Ink:

The ink composition which may be used with the present invention includes any liquid composition which may be applied onto the substrate in a predetermined pattern. Inks suitable for use with the present invention include but are not limited to those disclosed in commonly assigned U.S. Pat. No. 6,096,412 issued to McFarland et al. on Aug. 1, 2000, the disclosure of which is incorporated herein by reference.

Components of the ink composition may include but are not limited to: a vehicle such as a solvent or water; a colorant such as a pigment or a dye; a binder; and other components which may include but are not limited to wax, crosslinking agents, pH control agents, viscosity modifiers, defoamers, dispersants, printing press hygiene control agents, preservatives, and corrosion control agents.

As used herein, “ink” refers to any composition or components thereof applied to the substrate and which remains thereon in a visible pattern even though components of the ink may evaporate. The components of the ink composition may be applied to the substrate sequentially or as a mixture.

As used herein, “predetermined pattern” or “image” or “indicia” refers to any desired array or application of ink onto the substrate and is inclusive of all combinations of patterns ranging from small individual print elements to complete coating of the entire surface of the substrate. As used herein, “vehicle” refers to the liquid component of the ink composition utilized to convey the ink composition to the surface of the substrate. As used herein, “pigment” refers to insoluble color matter used in finely divided dispersed form to impart color to the ink. As used herein, “dye” refers to a colorant soluble in the continuous phase of the ink. As used herein, “binder” refers to the adhesive component of the ink composition.

Ink compositions which are suitable for use with the present invention include but are not limited to those ink compositions that are in the form of a liquid at room temperature (i.e.; a temperature of about 20° C.). The ink compositions will preferably utilize water as a vehicle and pigment as a colorant. Though the preferred ink compositions for use with the present invention are pigment-based process inks, other types of pigment-based and dye-based inks are also suitable and within the scope of this invention.

A binder may be needed for the ink to adhere to the surface of the substrate. In general, rub-off resistance of the ink composition increases as adherence of the ink to the surface of the substrate increases. As used herein, “rub-off” refers to the transfer of color from the surface of a printed substrate to another surface. Rub-off is composed of two components, bleed and abrasion. Bleed refers to the tendency of color to leach out of a substrate upon exposure of the substrate to a liquid. Abrasion refers to the ability to remove ink from a substrate by mechanically scuffing the ink from the surface of the substrate.

Ink compositions which include binders comprised of film-forming polymers tend to have improved adherence of the ink to the surface of the substrate in comparison to inks containing non film-forming binders.

A non-limiting list of optional additives which may be added to the finished ink compositions of the present invention include crosslinking agents, printing press hygiene control agents, humectants, corrosion control agents, pH control agents, viscosity modifiers, preservatives, and defoamers.

Crosslinking agents are generally added to the finished ink composition or to a pigment dispersion. As used herein, “finished ink composition” refers to an ink composition that contains the key components such as a vehicle, pigment, and binder so as to render the ink composition ready to use. As used herein, “pigment dispersion” refers to a composition comprised of pigment solids, surfactant, and a vehicle such as water or oil to which a binder is added.

Crosslinking agents are believed to enhance the rub-off resistance of the ink by crosslinking with the ink. Glycerin may also be added to the ink composition in order to improve rub-off resistance.

Methods of curing the inks of the present invention include but are not limited to thermally curing, electron beam curing, photon curing (for example ultraviolet light, x-ray, and gamma ray), and combinations thereof.

Applying the Image to the Substrate:

There are many ways in which inks can be deposited on a substrate. It is desirable that the process by which these inks are deposited on the substrate deliver consistent product over long periods of time. Suitable methods for depositing ink on a substrate which may be used in conjunction with the present invention include but are not limited to those disclosed in the following commonly assigned patent/patent applications: U.S. Pat. No. 6,096,412 issued to McFarland et al. on Aug. 1, 2000; WO 01/36209 published in the name of Forry et al. on May 25, 2001; U.S. application Ser. No. 09/638,237 filed in the name of Nissing et al. on Aug. 14, 2000; and U.S. application Ser. No. 09/929,132 filed in the name of Nissing on Aug. 14, 2001, the disclosures of which are incorporated herein by reference.

Ink may be applied to the substrate in any number of ways including but not limited to: dipping the substrate into a solution of ink, spraying a solution of ink onto the substrate, or preferably by printing the ink onto the substrate. Printing processes suitable for this invention include but are not limited to: lithography, letterpress, ink jet printing, gravure, screen printing, intaglio and preferably flexography. A single color image or multi-color image may be applied to the substrate.

Devices suitable for applying an image onto an absorbent disposable paper product include but are not limited to those described in commonly assigned U.S. Pat. No.: 5,213,037 issued to Leopardi, II on May 25, 1993 and U.S. Pat. No. 5,255,603 issued to Sonneville et al. issued on Oct. 26, 1993, the disclosures of which are incorporated herein by reference.

It should be noted that in order to reproduce the intended macroscopic image, the print elements must change in either size or proximity such that macroscopic variations to the color density create an aesthetically pleasing appearance. These variations in the print element size and proximity are typically referred to by the percentage of the area that constitutes print elements.

It should be noted that within some areas of the image, such as at the juncture of a 100% print area and a 50% print area, the shape of the print elements may appear irregular. Likewise, at the juncture of a 50% print area and an unprinted region, the border between these two areas may appear irregular.

The printed image produced on the paper can be line printing, halftones, a process print, or a combination of these. As used herein, “process print” refers to a halftone color print created by the color separation process whereby an image is broken down into halftone print elements which can be recombined to produce the complete range of colors of the original image.

Coloration in a process print image is produced by varying the area of ink deposition in a given image area, frequency of ink deposition, and the number of inks in the image area. Ink deposition area may be varied by adjusting the frequency, size, or combination thereof of print elements.

An image is process printed, if the image is printed with multiple process colors. Furthermore, the inks must produce a multitude of colors when the inks are overlayed. The advantage of a process printed image is that the process printed image enables many colors and shades of those colors to be produced with a few inks. For example, a human image may be comprised of ten or more colors. This image can be reproduced by process printing utilizing as few as three colors.

While the present invention may be used in conjunction with any combination of single color, multi-color, or process printing, it is of particular use in process printing.

Furthermore, the present invention is particularly useful for printing applications which have low contrast. Examples of this include but are not limited to printing yellow ink on a white substrate, printing magenta ink on a pink substrate, printing cyan ink on a blue substrate, etc. While not wishing to be bound by theory, it is believed that in such applications the linear print elements 10 are not visible to the end user. For example, when using linear print elements 10 on a yellow station when process printing on a white substrate or off-white substrate, the linear print elements 10 are generally not visible to the end user.

As is commonly known, the spacing of the print elements can have a significant impact on the visibility of individual print elements to the end user. This spacing is generally referred to as, “linescreen” wherein the linescreen of a set of print elements is the number of print elements per linear inch. For linear print elements 10, the measurement should be made perpendicular to the axis of the print element. A typical linescreen is generally at least about 45 lines per inch and more preferably at least about 65 lines per inch.

It should be noted that there are numerous screening techniques of varying linescreen within a print image 30 to alter the macroscopic appearance of the image. One such non-limiting example is stochastic screening. Print images 30 comprising linear print elements 10 in combinations with these screening techniques are within the scope of the present invention.

Printing Plate:

As used herein, “printing plate” refers to a surface carrying an image by which the ink is ultimately transferred directly or indirectly to the material to be printed. Printing plates suitable for use with the present invention can be made from a wide variety of commercially available materials. For instance, these plates can be made using typical photopolymeric processes, familiar to those of ordinary skill in the art. Non-limiting examples of suitable plate materials include those commercially sold under the trade names of SPLASH®, FL-AL, and BPS™ all of which are available from MacDermid Incorporated of Wilmington, Del. Other types of suitable printing plates include but are not limited to mechanically engraved printing plates and laser engraved printing plates. Furthermore, it should be noted that suitable printing plates may include but are not limited to segmented plates and plates mounted on sleeves.

Suppliers of printing plates suitable for use with the present invention include but are not limited to Precision Rubber Plate, Incorporated of Indianapolis Ind.

Printing Press Plate Cleaning:

A printing plate made in accordance with the present invention in combination with a print plate cleaning device can provide an effective system for improving printing press hygiene. Ink or fiber deposits on the printing apparatus can require manual intervention to remove. Significant manual intervention causes unacceptable costs to be associated with the process. Therefore, it is desirable to limit the amount of manual intervention needed to print reliably and consistently.

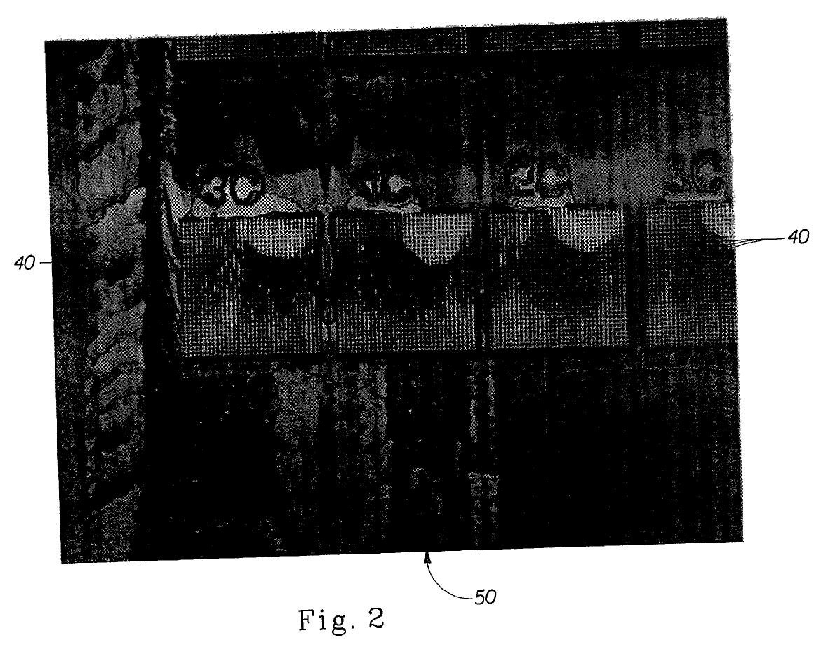

In particular, typical flexographic plates are generally made with relatively round dot 40 patterns as shown in the prior art print plate 50 of FIG. 2. These dots 40 allow significant amounts of ink and fiber to be deposited in the recessed areas between the dots 40.

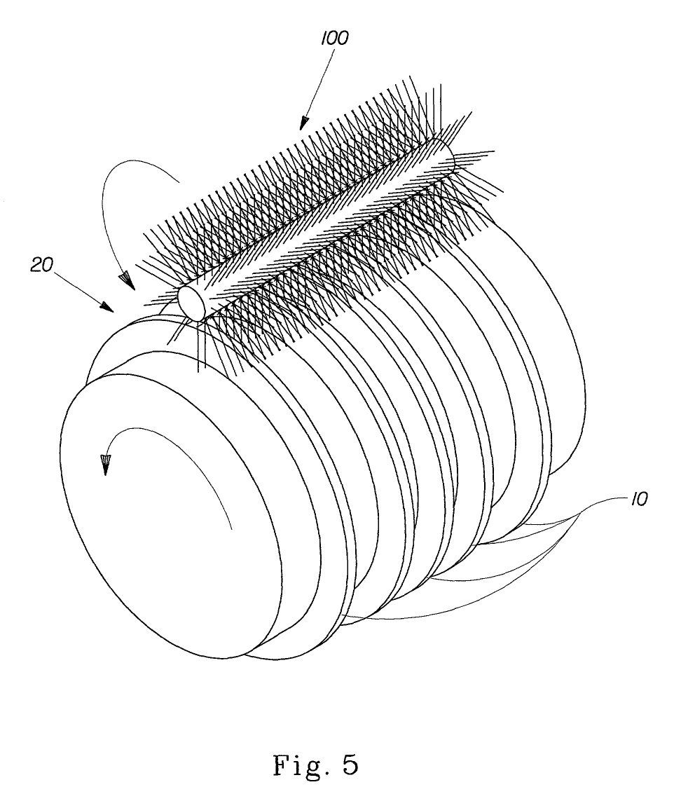

Referring to FIGS. 1 and 5, print plates 20 comprised of linear print elements 10 allow for more efficient removal of ink and fiber from flexographic printing plates. While not wishing to be bound by theory, it is thought that more efficient removal of ink and fiber are possible with the present invention because the recessed surface area between the individual linear print elements 10 is more appropriately aligned with the direction of a print plate cleaning device than a circular print element (such as the dots 40) shown in the prior art printing plate 50 of FIG. 2.

In the case of circular print elements such as the dots 40 shown in the prior art print plate 50 of FIG. 2, the valleys created by a plurality of circular print elements exist in multiple directions. These valleys are primarily responsible for trapping lint, ink, and other contaminants on the surface of the plate and creating print defects as shown in the prior art printing plate of FIG. 2. In the case of printing dots with a regular rectilinear screening technique, these valleys will extend in two orthogonal directions. While it may be possible to align one of these directions with the orientation of the cleaning system, it is not possible to align all of the valleys with the orientation of the cleaning system.

While not wishing to be bound by theory, printing plates are most effectively cleaned by print plate cleaning devices when the print elements are aligned parallel to the machine direction. However, it should be understood that slight deviations from parallel may yield similar results. For example, 1 or 2 degrees away from the machine direction will be much more effective than 45 degrees. Preferably the deviation from machine direction is about 15 degrees or less, more preferably about 10 degrees or less, and even more preferably about 5 degrees or less.

Referring to FIGS. 1 and 5, the present invention enables the print plate cleaning device 100 to contact nearly all surfaces of the printing plate 20 by more suitably aligning the linear print elements 10 with the print plate cleaning device 100. In particular, the longer the linear print elements 10 are in a direction relatively parallel to the machine direction, the more effective the print plate cleaning device 100 can be.

One non-limiting suitable example of a print plate cleaning device 100 is a rotary cleaning brush. The diameters of the rotary cleaning brush bristles are generally between about 0.005 inches (0.127 mm) to 0.015 inches (0.381 mm), preferably between about 0.008 inches (0.2032 mm) to 0.012 inches (0.3048 mm), and most preferably about 0.010 inches (0.0254 cm). In some instances a water source is combined with a rotary cleaning brush.

Suitable rotary cleaning brushes are available from The Industrial Brush Company, Inc. of Fairfield, N.J. as Part Number 55082. These brushes have a 4 inch (10.16 cm) carbon fiber composite core with a 1 inch (2.54 cm) filament length. It should be realized that the print plate cleaning device need not be engaged at all times but may be used intermittently.

In the case of the linear print elements 10 of FIGS. 1 and 5, the valleys can be substantially aligned in the direction of the print plate cleaning device 100. For example, if linear print elements 10 are used in conjunction with a print plate cleaning device 100 such as a rotary brush cleaning system, aligning the linear print elements 10 so that they are parallel to the machine direction of the printing plate 20 will orient the valleys between the linear print elements 10 so that they are parallel to the travel of the brush bristles while in contact with the print plate 20 surface. In this case, the bristles can contact almost the entire surface of the print plate 20. This is not possible when utilizing print elements consisting primarily of dots 40 such as shown in FIG. 2, as the valleys are created in multiple directions and thus the cleaning system is unable to remove all of the deposits which may remain between the dots 40 because the brushes do not contact all areas between the dots 40. This precludes the cleaning system from contacting all surfaces. Hence, the cleaning efficiency of a process utilizing the linear print elements 10 of the instant invention as shown in FIGS. 1 and 5 is greatly improved over the prior art.

In addition to rotary brush cleaning systems, another non-limiting example of a suitable print plate cleaning device which may be used in conjunction with the present invention is disclosed in commonly assigned U.S. patent application Ser. No. 10/043,832 filed in the name of Boatmann et al. on Jan. 11, 2002.

### METHODS AND EXAMPLES

### Method 1

### Determining the Length to Width Ratio of Print Elements

1.) Magnify the printed indicia using a lens or other suitable device for magnification. The amount of magnification required may be dependent on the linescreen of the print to be examined. Generally, magnification in the range of 10× to 100× is sufficient. Measure the longest axis of the print element as length, L, using a linear measuring tool. Note: 100% printed areas should not be included in this measurement since, by definition, these areas have no distinct print elements. Additionally, for a process printed sample, it may be necessary to find a segment of print in which the minimum amount of overlays is present. For process printed samples, the measurements should be made independently for each distinct color.

2.) Measure the width of the print element perpendicular to the measurement of L as width, W.

3.) The aspect ratio is computed as R=L/W.

4.) An average of 12 measurements should be taken from the same sample in order to minimize normal variation.

### Example 1

### A flexographic embodiment of the present invention.

1). Flexographic printing plates available from Precision Rubber Plate Incorporated of Indianapolis, Ind. as Part No. 993194 were used for this purpose.

2.) The inks used for this process were supplied by Sun Chemical of Menasha, Wis. The inks used were as follows:

Yellow ink sold as WKKFW2619194

Magenta ink sold as WKKFW4619195

Cyan ink sold as WKKFW5619196

Black ink sold as WKKFW9619197

3.) The plates and inks were used on a four-color flexographic printer. Each of the four stations utilized print elements made according to the prior art. Additionally, the yellow print station also utilized linear print elements made according to the present invention.

4.) The squeeze settings and registration were adjusted using standard techniques.

5.) The printer was equipped with a rotary brush cleaning system. The brush utilized for this purpose was purchased from The Industrial Brush Company, Incorporated of Fairfield, N.J. as Part No. 55082.

As can be seen from FIG. 1, the print plate comprised of linear print elements 10 made in accordance with the present invention exhibits less build-up than the prior art print plate of FIG. 2.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A linear print element, said linear print element comprising an aspect ratio of at least about 2.

2. The linear print element of claim 1 wherein said aspect ratio is at least about 3.

3. The linear print element of claim 2 wherein said aspect ratio is at least about 5.

4. A printing plate for a printing press, said printing plate comprising:
at least one linear print element, said linear print element having one dimension which is oriented substantially parallel to the machine direction of said printing press, said linear print element having an aspect ratio of at least about 2.

5. The printing plate of claim 4 wherein said aspect ratio is at least about 3.

6. The printing plate of claim 5 wherein said aspect ratio is at least about 5.

7. The printing plate of claim 4 wherein said printing plate is a flexographic printing plate.

8. A printed paper product, said printed paper product comprising an image said image comprised of one or more linear print elements said linear print elements having an aspect ratio of at least about 2.

9. The printed paper product of claim 8 wherein said aspect ratio is at least about 3.

10. The printed paper product of claim 9 wherein said aspect ratio is at least about 5.

11. The printed paper product of claim 8 wherein said printed paper product is flexographically printed.

12. The printed paper product of claim 8 wherein said image is a process print.

13. The printed paper product of claim 8 wherein said paper product is an absorbent disposable paper product.

14. The printed paper product of claim 8 comprising a plurality of linear print elements.

15. A system for improving printing press hygiene, said system comprising:
(a) providing a flexographic printing press having a at least one flexographic print plate wherein said flexographic printing plate is comprised of linear print elements; and
(b) providing a print plate cleaning device wherein said print plate cleaning device contacts said flexographic print plate.

16. The system of claim 15 wherein said print plate cleaning device contacts said flexographic print plate on an intermittent basis.

17. The system of claim 15 wherein said linear print elements have an aspect ratio of at least about 2.

18. The system of claim 15 wherein said print plate cleaning device is comprised of a rotary brush cleaning system.

19. The system of claim 15 wherein said linear print elements are aligned substantially parallel to the machine direction of said flexographic printing press.

20. The system of claim 18 wherein said linear print elements are aligned substantially parallel with the motion of the brushes of said rotary brush cleaning system.

21. A system for improving printing press hygiene, said system comprising:
(a) providing a flexographic printing press having a at least one flexographic print plate wherein said flexographic printing plate is comprised of linear print elements, whereby said linear print elements have an aspect ratio of at least 2 and said linear print elements are aligned substantially parallel to the machine direction of said flexographic printing press;
(b) providing a print plate cleaning device comprised of a rotary brush cleaning system; and
(c) contacting said flexographic print plate with said rotary brush cleaning system on a periodic basis.

22. A method for printing on absorbent disposable paper, said method comprising the steps of:
(a) providing an absorbent disposable paper;
(b) providing a flexographic printing plate wherein said flexographic printing plate is comprised of a plurality of linear print elements whereby said plurality of linear print elements forms an image and wherein each individual linear print element has an aspect ratio of at least about 2;
(c) applying ink to said plurality of linear print elements; and
(d) contacting said plurality of linear print elements to said absorbent disposable paper so as to transfer said image from said plurality of linear print elements to said absorbent disposable paper.

23. The method of claim 22 wherein said flexographic printing plate is mounted on a sleeve.

24. The method of claim 22 wherein said flexographic printing plate is segmented.
